(19) United States
(12) Patent Application Publication
(10) Pub. No.: US 2005/0125323 A1
(43) Pub. Date: Jun. 9, 2005

(54) Method of distribution and management of fractional interests in a property or security

(76) Inventor: Marc S. Warren, Bala Cynwyd, PA (US)

Correspondence Address: David M. Warren, 655 Oakland Ave., Cedarhurst, NY, 11516, US

(21) Appl. No.: 10/728,488

(22) Filed: Dec. 5, 2003

(51) Int. Cl. G06F 17/60

(52) U.S. Cl. 705/35; 705/36

(57) ABSTRACT

A method for managing the assets of holders of portions of the rights in shares of a property is accomplished by steps of acquiring shares of ownership in a property or a security of a business enterprise. The fractional rights are acquired by an administrator of the fractional rights and of a market maintained for trading the fractional rights. The administrator divides the share of the property or security into portions, such as the right to receive a dividend and the right to receive capital appreciation. A limited duration of time may be established for the fractional right, after which the fractional right may revert to a holder of residual rights. In the market, the administrator may sell rights to investors and is willing to repurchase the rights from the investors.

### BACKGROUND OF THE INVENTION

This invention relates to a method of distribution and management of interests in a property or security among a group of investors and, more particularly, to the distribution and management of such interests wherein an interest is created by division of a property right, including a stripping of a portion of a property right for a limited duration of time.

The ownership of property, or of certain interests in a property, by a group of investors is a common occurrence. As an example, one may consider ownership of real property, such as a condominium, wherein individual investors, or owners, own their respective apartments to the exclusion of the other owners, while sharing in the ownership of common areas such as hallways and courtyards. As an alternative form of the ownership, several or more owners may own the same apartment at different times during a year, as is accomplished with a time-share arrangement. The picture of the ownership rights in the condominium becomes more complex when an owner rents his apartment to a renter for a limited duration of time, such as a year, in which case the renter enjoys exclusive possession of the apartment for the year (to the exclusion of the owner), which possession reverts back to the owner at the end of the year. Often, the right of ownership or other property right is evidenced by a negotiable instrument such as a stock certificate showing ownership of a certain number of shares in a corporation. Stocks and bonds may be referred to as securities and, accordingly, the use of the term “property” herein is understood to include securities. At times, herein, the description of the invention employs both of the terms “property” and “security” to emphasize that an aspect of the invention applies also to securities.

As a further example, one may consider ownership of a corporation, wherein an investor's interest in the ownership is evidenced by a share of stock in the corporation. Different investors in the corporation may own different amounts of the stock, wherein the number of shares of the stock is a measure of the amount of ownership. The picture of the ownership rights in the corporation becomes more complex when the corporation issues different classes of stock. By way of example, such differences in the classes of stock may concern the presence or absence of voting rights for management of the corporation, or the right to receive a dividend in one class of stock in preference of the right to receive a dividend in another class of the stock as in the case of a preferred share of stock, or the right to convert between different classes of stock subject to certain conditions, or the attachment of warrants to a stock giving the right to purchase additional shares subject to certain conditions, or the designation of the value of a stock to a specific area of the corporate business as in a tracking stock.

As yet another example, one may consider an investor's ownership in a right to receive a payment in retirement of a debt, as in the case of an owner of a bond issued by a corporation. Such a bond may give the owner (the bondholder) the right to receive the principal amount at a certain date, or may require also that the bondholder accept an earlier payment of the principal amount at the will of the corporation, and provide that interest be paid to the bondholder in a single lump sum at a certain date, or be provided with coupons attached to the bond to be clipped at certain dates and submitted to an agent of the corporation to receive a partial payment of the interest.

As is well known, investors often attempt to trade their interests in properties, such as the aforementioned examples of real property, corporate stock and corporate bonds, as well as other forms of property, in a marketplace. Generally, such trading is accomplished by buying or selling an interest for cash, frequently by means of a broker. Often a broker or an underwriter or a specialist establishes and/or maintains a market in a specific security or class of securities. For example, an underwriter may obtain a large quantity of bonds from a corporation for cash, and then sell the bonds in smaller quantities to the public. An underwriter may market a secondary offering of shares of stock to the public. The underwriter or the broker may alter the form of a security, as in the situation wherein the underwriter, or a broker who obtains a quantity of the bonds from the underwriter, may strip the coupons off of a bond, and sell the bond and the coupons separately. Such alteration of the security facilitates a marketing of the security by adjusting the risk of ownership to ownership of a specific right in the security (the principal amount or the interest in the bond), rather than ownership of the complete security.

The foregoing examples demonstrate that, in the ownership of a property or a security, one may own all rights associated therewith, or only a portion of the rights. The portion of the rights may relate to the kind of right and/or to a period of time in which the right is available. The portion of the rights available to an investor may be established by an original owner of a property, such as in the selling- of an individual apartment or time share by the developer/builder of the condominium. Alternatively, the portion of the rights available to an investor may be established by an underwriter as in the case of the splitting of the coupons from a bond issued by a corporation. It is appreciated that a stripping off of a right from the totality of all rights associated with a property or a security, in conjunction with a marketing of the stripped-off right, may be useful in the marketplace for enhanced trading in properties and securities with adjustment of the risk of ownership to the needs of an individual investor. Unfortunately, the present marketplace does not have the capacity for alteration of numerous forms of properties and/or securities, particularly with reference to the various forms of stock that may be issued by a corporation.

### SUMMARY OF THE INVENTION

The aforementioned disadvantage is overcome and other advantages are provided, in accordance with the invention, by a method of distribution and management of interests in a property or security among a group of investors, including the creation of such interest by separation of at least one right from the totality of rights associated with a property or security, wherein the separation may be for a limited duration of time. The methodology of the invention provides for managing the assets of holders of portions of shares of rights in a property, and is accomplished by various ones of the following steps.

Initially, there is an acquiring of ownership in a property or a security of a business enterprise. The ownership is usually evidenced by a share of stock or a bond, in the case of a corporation, or other form of share as in the case of a partnership or other form of enterprise. Each share of stock and each denomination or unit of bond constitutes a set of rights. The acquiring of the rights would be done, typically, by an underwriter or broker who deals with officers of the enterprise to acquire a large quantity of securities issued by the enterprise, whereupon the underwriter or broker arranges for the sale of the securities to members of the public. Alternatively, the underwriter or broker may acquire the securities in the open market, and then arrange for the sale of the securities to the members of the public.

Prior to the selling of the securities to the public, and in accordance with a feature of the invention, the underwriter or broker divides each unit of a security, such as a share of stock or a denomination of bond, into portions, with each of the portions having at least one of the aforementioned rights. For ease of nomenclature, the portion of fraction of the total rights in the security may be referred to as a fractional right. By way of example, such division of the rights to a bond may be accomplished by stripping off coupons from the bond. By way of further example, such division of the rights to a share of stock may be accomplished by deletion of the right to receive a dividend, whether or not the corporation is presently considering the payment of a dividend now or only at a future time, and offering for sale the right to receive such dividends as may be declared within a period of time such as during the next five years. Typically, at least one of the portions of the security is an equity portion with an equity right, and at least another one of the portions is a non-equity portion with a non-equity right that has been stripped off, or divided out, from the equity portion. In the event that a divided-out non-equity portion of the share is to have a limited duration of time, such as in a range of three months to three years by way of example, the underwriter or broker would perform the additional method step of designating a limited duration of time of existence for the non-equity portion.

The methodology then continues with a step of establishing a market in the portions of the securities. In the market, there is a selling of individual ones of the portions to investors, and also a buying of individual ones of the portions from the investors. In the well-known case of the operation of a stock market, a specialist acts as the market maker, and may arrange for a transfer of ownership of a block of many shares of a security between a buyer and a seller, or may sell smaller quantities of shares from his own account to investors and buy smaller quantities of shares from investors to replenish his own account, so as to maintain the flow of securities among investors of the market. So too, in the case of the present invention, there is a specialist or market-maker who maintains the market in full units of the security (such as a stock or bond) and maintains the market also in the fractional portions of the securities, such as the portions of the rights to stocks and bonds described above. In particular, it is emphasized that, in accordance with a feature of the invention, the market-maker maintains a store of fractional rights in the security or property being traded in the market, which store is used to maintain a regular pattern of trading by a selling of fractional rights from the store, and by a buying of fractional rights to replenish the store.

Normally, in a transfer of stock from one owner to another owner, the corporation or an agent of the corporation monitors changes of ownership so that a stockholder can be notified of matters affecting the operation of the corporation. By way of example, in order for the buyer of the stock to collect a dividend, assuming that the buyer has bought the right to collect the dividend, it is necessary for the dividend to be communicated from the business enterprise (presumably a corporation) to the buyer. However, in the situation of the present invention, wherein partial rights in a security or other property may be traded frequently, it is envisioned that the underwriter or broker would serve as the specialist or market-maker for the conduction of the trading, and would also serve as an administrator for the keeping of records of ownership, and for the dissemination to the investors of dividends of cash as well as additional shares of stock and warrants that have been received by the administrator from the corporation in a capacity of trustee for owners of partial rights in a security.

For ease of nomenclature, the person or organization that performs the foregoing tasks in the establishment and maintenance of the market may be referred to hereinafter as a security distribution administrator, or simply the administrator. Thus, the steps of the method of the invention from the underwriting, or acquisition of the securities, to the division of rights of a security or property, as well as the maintenance of the market and communication with the security holders (the investors) for an orderly trading and determination of price of a security, are performed by the administrator.

In the foregoing description, the invention has been described in terms of its use in the investment community. However, in the general case, the invention can be viewed in terms of the administration of a property or object of value, in conjunction with the distribution of portions of the property to end-users of the portions of the property, the transfer of the portions of the property among the end-users, plus subsequent monitoring of a relationship between the source of the property and the end users of the divided-out portions of the property. By way of example, one may consider the aforementioned time-share arrangement in which the ownership rights to a time-share apartment may be transferred among numerous persons over a period of years. In the event of the sale of a part of the real estate owned by the condominium organization, the administrator would distribute the proceeds of the sale to the respective owners of rights to the condominium apartments in the manner of a dividend. Or possibly the condominium organization conducts a business on the premises, such as a restaurant open to the public, then the administrator distributes profits from operation of the restaurant to the respective owners of rights to the condominium apartments in the manner of a dividend.

By way of further example in the division of rights (generally owned by an owner of a time-share apartment) to obtain a fractional right to be traded in a market, one may consider the situation of a prospective buyer of a time-share apartment who is willing to buy the apartment at a reduced price, with the understanding that he can sell it back to the administrator at the same price a few years later. To deal with this situation, the administrator creates a suitable fractional right in the following manner. It is recognized that the total price paid for a time-share apartment, based on present market conditions, may be regarded as being composed of a base value plus an increment associated with anticipated capital appreciation. In other words, if the market value of the time-share apartment has been rising steadily and is believed to continue to rise, then a buyer is willing to pay a higher price for the apartment than would be paid if the market value had remained constant and is believed to remain constant in the foreseeable future. The increase in value of the time-share apartment is referred to herein as capital appreciation. Normally, a buyer has the right to receive the capital appreciation when he sells the property. However, in the present situation, the practice of the invention would enable the administrator to strip off the right to receive the capital appreciation from the set of rights normally received by the buyer, and to sell, to a third party, the right to receive the capital appreciation. The third party, as an investor, is willing to invest funds in the hope of receiving a profit from the capital appreciation attained when the buyer sells the apartment back to the administrator. Since the administrator is receiving funds from the third-party investor, he can sell the time-share apartment to the aforementioned buyer at a lower price. Thereby, the administrator receives money from the buyer of the apartment and from the third-party investor, the buyer of the apartment gets to use the apartment at a reduced cost, and the third-party investor makes a profit if the market price rises sufficiently.

It is to be understood that, in the application of the invention to the foregoing example of the time-share apartments, the administrator performs other tasks in addition to those often performed by a real-estate broker. The administrator acquires ownership of the apartments before offering them to the public, determines how the property rights are to be divided, sells portions of the property rights from his own account to investors, and will buy back the portions of the property rights from the investors to replenish his own account so as to maintain the flow of property among investors of the market. It is understood further that an administrator, himself, may be the owner of a corporation or other enterprise, and may want to conduct a market in fractional rights of shares in the corporation. For purposes of practicing the invention, the administrator may be considered to have acquired already the shares in the corporation, and may proceed with the step of dividing the complete rights of a share into the partial rights of the market.

The foregoing description of the invention has been simplified by regarding the administrator to be a single person who performs the aforementioned functions of the administrator. However, in practice, particularly in an active market, the tasks assigned to the administrator would be accomplished by a group of people, including an underwriter who advances the funds to acquire the property to be traded and who (possibly with the aid of a staff) established the fractional rights, a specialist who conducts the trading and determines the market price of each fractional right, the clearing personnel who verify that funds have been received for the traded properties and that the traded properties are identified with the correct parties to the transaction, a transfer agent who maintains the records of who owns what properties, and a bank which disburses the funds during acquisition of property by the administrator and receives funds during a sale of property by the administrator. The bank would also tend to the receipt of dividend finds from a corporation and the dissemination of dividends from the funds to those investors entitled to receive dividends according to the records of the transfer agent.

### BRIEF DESCRIPTION OF THE DRAWING

The aforementioned aspects and other features of the invention are explained in the following description, taken in connection with the accompanying drawing figures, wherein:

FIG. 1 is a diagram showing the establishment of a market for the trading of fractional rights in a property, including distribution and management of fractional interests in a security, in accordance with the methodology of the invention; and

FIG. 2 is a state diagram presenting an example of a division of rights in a security prior to a trading of fractional rights in a market, followed by a repurchase of the fractional rights, and reversion of the fractional rights to a holder of residual equity rights in the security.

### DETAILED DESCRIPTION OF THE INVENTION

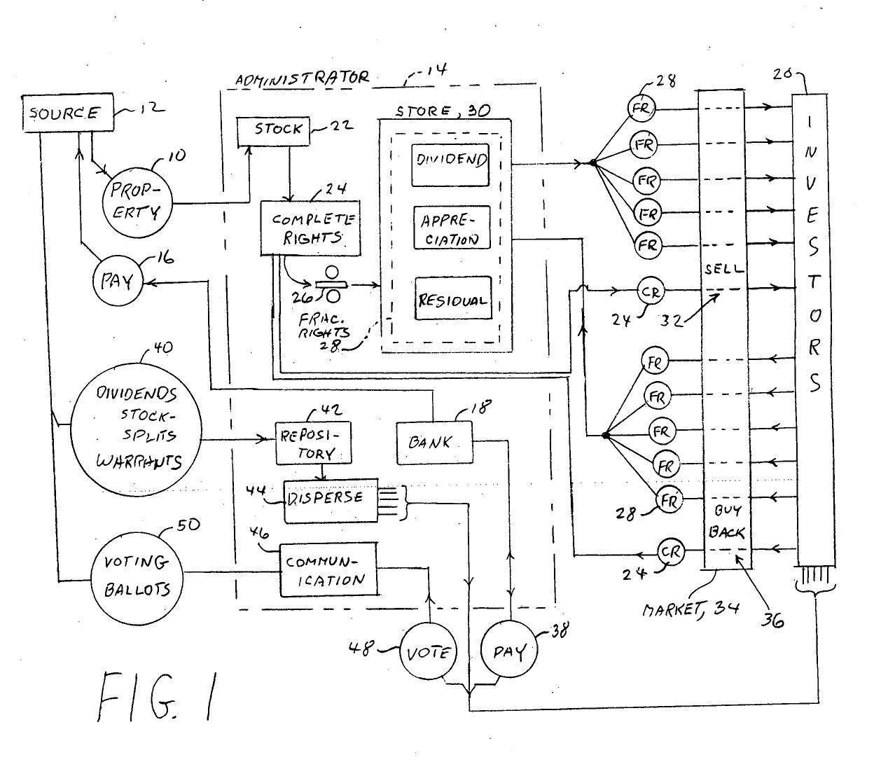

The methodology of the invention, including the acquisition of property and the division of rights of to the property into fractional rights by the administrator, as well as the maintenance of a market in the fractional rights, is described with reference to FIG. 1. As shown in the figure, property 10 is transferred from a source 12 of such property to an administrator 14 as payment 16 is transferred from the administrator 14 to the source 12. By way of example, the payment 16 may be cash provided by a bank 18 of the administrator 14. The property 10 may be securities such as shares of stock in a corporation, or denominations of the bonds issued by the corporation. By way of further example, the property 10 may be rights in time-share apartments, or ownership of an apartment house. The property 10 may also be objects having long term depreciation, such as pianos, in which situation the administrator 14 would be willing to maintain a market for used pianos according to a depreciation schedule based on age. The source 12 may be a corporate officer in the case of the securities, a developer of real estate in the case of the apartment house, and a manufacturer of pianos in the case of the maintaining of a market in objects having long term depreciation.

After acquiring the property 10 from the source 12, the administrator 14 divides the complete package of rights associated with the property 10 into parcels of rights, or fractional rights, which are marketable to investors 20. This may be demonstrated for the case of a property in the form of shares of stock 22, wherein the complete package of rights (CR) 24 is divided (indicated at 26) into fractional rights (FR) 28 which are held in a store 30. By way of example, the rights held in the store 30 may include the right to a dividend, the right to receive capital appreciation, and residual rights in a share of stock after deletion of the dividend and/or appreciation rights. The rights held in the store 30 may be sold (indicated at 32) by the administrator 14 via a market 34 to the investors 20, and the rights held by the investors 20 may be bought back (indicated at 36) by the administrator 14 via the market 34 to replenish the store 30. If desired, complete rights 24 also may be sold by the administrator 14 to the investors 20, and bought back from the investors 20 by the administrator 14. During purchase of the property rights by the investors 20 from the administrator 14, payments 38 pass from the investors 20 to the bank 18 of the administrator 14. During the repurchase of the property rights by the administrator 14 from the investors 20, payments 38 pass from to the bank 18 of the administrator 14 to the investors 20.

The administrator 14 provides other administrative functions to maintain the relationship between the source 12 and the investors 20. By way of example, further rights to be dispensed by the source 12 to the investors 20 include property rights 40 such as dividends, stock splits, and warrants. Property rights 40 are held in a repository 42 of the administrator 14 for disbursement 44 by the administrator 14 to respective ones of the investors 20. Also, by way of further example, the administrator 14 may provide for communication 46 of voting materials between the source 12 and the investors 20, such as voting on matters requested by a Board of Directors of a corporation, whereby investors 20 indicate their votes 48 on ballots 50 which are transmitted by the administrator 14 from the investors 20 to the corporation of the source 12.

The operation of the invention, as depicted in FIG. 1, applies to various forms of property rights and to various forms of payment which may be made in the acquisition of the property rights. By way of example, while payment is normally made in cash, payment may also be made in other forms of property, such as by surrendering a stock certificate. Also, is noted that, to facilitate the conduct of business in the market 34, it is useful to limit the duration of a strip of security rights to a period no longer than, possibly, five years, whereupon rights in the strip revert the holder of the residual interest. The foregoing suggested period of five years is to facilitate the maintenance of the market, but is not a requirement of the invention since the methodology of the invention is operative also in the situation wherein rights are held for an indefinite period of time. The accounting and record-keeping matters relating to such reversions of stripped rights can be accomplished readily by the administrator 14. Thereby, a person who has purchased a share of stock without the right to receive a dividend, would regain the right to receive the dividend at the conclusion of the five-year period. In similar fashion, it would be advantageous to have another form of stripped-off right, such as the right to receive capital appreciation, revert from the owner of the stripped-off right to the owner of the residual rights at the conclusion of the five-year period.

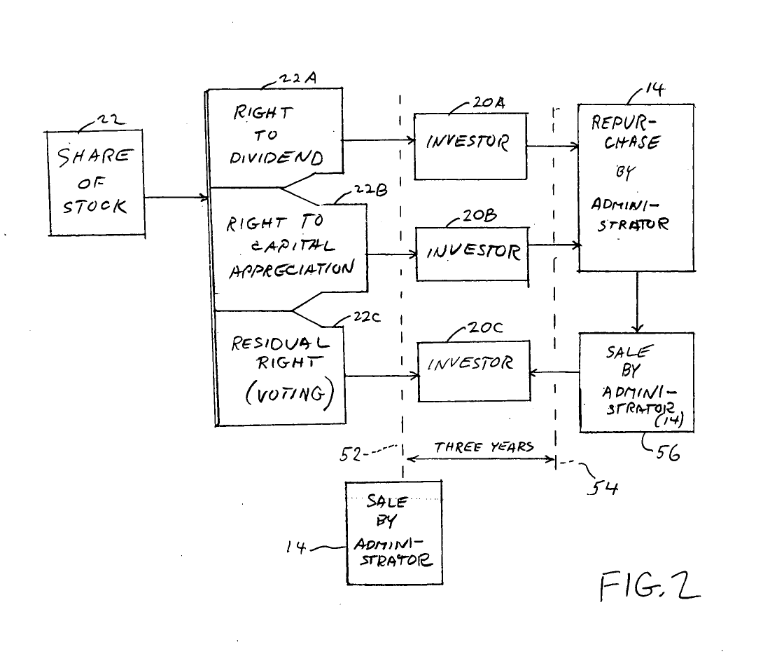

This is demonstrated in FIG. 2 which shows, diagrammatically via a state diagram, the procedure of the invention wherein a share of stock 22 is divided by the administrator into fractional rights indicated, by way of example, as the right 22A to receive a dividend, the right 22B to receive capital appreciation, and the residual rights 22C including the right to vote in corporate matters. Then, at a point in time indicated by a time line 52, the administrator 14 sells the fractional rights 22A, 22B and 22C respectively to investors 20A, 20B and 20C. Subsequently, at a later point in time, such as three years later as indicated by a time line 54, the administrator 14 repurchases in the rights 22A from the investor 20A and also repurchases the rights 22B from the investor 20B. In this example, it is assumed that the rights 22A and 22B expire after 3.5 years so that, at the time line 54, these rights have relatively little value left. Accordingly, for a relatively small price, the administrator 14 is able to sell (indicated at block 56) these rights to the investor 20C. Thereby, the investor 20C obtains complete rights to the share of stock 22.

It is contemplated in the practice of the invention that, the foregoing securities may be traded in more than one market and that there may be multiple administrators who cooperate in the trading of such securities. Thus, in the example of FIG. 2, one administrative may have bought the rights from the investor 20A and a second administrator may have bought the rights from the investor 20B, and wherein the investor 20C has bought the respective rights 22A and 22B from the two different administrators. Also, in the practice of the invention, it is noted that, by way of further example in the splitting of a right, such as the right to a dividend, investors may be willing to purchase the right to only half of the dividend or some other fraction of the dividend rather than purchasing the right to the complete dividend, as has been described in the foregoing examples.

In the foregoing examples of the division of the complete package of rights into the factional rights, it is noted that the residual right is an equity right, while a split-off right, such as the right to receive the dividend for an indefinite period of time or for a limited period of time is a non-equity right, or a non-equity portion of the complete package of rights appurtenant to ownership of the property.

The following additional example in the implementation of the invention is provided. The administrator may sell a share of stock to an investor subsequent to a stripping off of the right to receive a dividend for the next five years. The loss of the right to receive the interest for the five year period may be referred to as a strip. The stripped-off right to receive the dividend is sold to another investor, or might remain in the store 30 of FIG. 1 in the event that the administrator is unable to find a buyer for the dividend right. At the beginning of the sixth year, the buyer of the share of stock regains the stripped-off dividend right and begins to collect the dividend for the sixth year, and for subsequent years as though there had been no strip. In other words, after the five years, the owner of the equity receives the right to receive future dividend payments. In this example, the buyer of the share of stock (the equity owner) pays less for the share of stock. Presumably, some one else may want to buy the strip, and the administrator, who accepts payment for the equity, also receives a payment from the holder (or buyer) of the strip, namely, the right to receive the dividends for the five year period. Depending on market conditions, the administrator may net more or less money for the equity and the strip separately, than for a complete share of stock. This example applies also to the sale of a bond without the right to receive interest due on the bond, wherein, after a period of time (such as the foregoing five-year period), the buyer of bond regains the right to receive the interest payments.

It is to be understood that the above-described embodiments of the invention are illustrative only, and that modifications thereof may occur to those skilled in the art. Accordingly, this invention is not to be regarded as limited to the embodiments disclosed herein, but is to be limited only as defined by the appended claims.

1. A method for managing the assets of holders of rights in a property, comprising the steps of:
acquiring shares of ownership in a property, wherein each of the shares constitutes a set of rights;
dividing the set of rights into portions, each of the portions having at least one of the rights; and
establishing a market in the portions, wherein in said market, there is a selling of the portions to investors and a repurchasing of the portions from the investors, said repurchasing enabling a holder of one of said portions to regain a divided-out right from one of said investors.

2. A method according to claim 1, wherein in said dividing step, at least one of the portions is an equity portion with an equity right and at least another one of the portions is a non-equity portion with a non-equity right that is stripped off from an equity portion, and wherein said repurchasing enables a holder of an equity portion to regain a non-equity right from one of said investors.

3. A method according to claim 2, wherein said dividing step includes a step of designating a limited duration of time of a fractional right in one of said portions.

4. A method according to claim 3 wherein said limited duration of time of a fractional right is in a non-equity portion.

5. A method according to claim 4 wherein the holder of the equity portion regains the non-equity right after expiry of said limited duration of time.

6. A method according to claim 1, wherein said dividing step includes a step of designating a limited duration of time of a fractional right in one of said portions.

7. A method according to claim 6 wherein the holder of said one portion regains the divided-out right after expiry of said limited duration of time.

8. A method according to claim 1, wherein said steps of acquiring share, dividing a set of rights, and establishing a market are accomplished by an administrator.

9. A method according to claim 8, wherein the administrator accomplishes a further step of disbursing dividends from the property to such ones of the investors who have rights to receive a dividend.

10. A method according to claim 8, wherein the administrator accomplishes a further step of transmitting votes to a management of the property from such ones of the investors who have rights to vote on matters relating to management of the property.

11. A method according to claim 8, wherein each of said portions constitutes a fractional right of the set of rights in a share of ownership in the property, said dividing step includes a step of designating a limited duration of time of the fractional rights in said portions sold to investors by the administrator, and said repurchasing step enables one of said investors, who is a holder of said one portion, to regain fractional rights from a plurality of said portions sold to other ones of said investors, thereby to obtain complete rights to the share of ownership of said holder.
